(19) United States
(12) Patent Application Publication
(10) Pub. No.: US 2024/0386659 A1
(43) Pub. Date: Nov. 21, 2024

(54) COLOR METADATA BUFFER FOR THREE-DIMENSIONAL (3D) RECONSTRUCTION

(71) Applicant: QUALCOMM Incorporated, San Diego, CA (US)

(72) Inventors: Kapil GARG, Fremont, CA (US); Sriganesh BALAKUMAR, San Jose, CA (US); Yifan ZHANG, San Jose, CA (US)

(21) Appl. No.: 18/318,576

(22) Filed: May 16, 2023

(51) Int. Cl. G06T 17/00; G06V 10/56

(52) U.S. Cl. CPC G06T 17/00; G06V 10/56

(57) ABSTRACT

Systems, methods, and computer-readable media are provided for a color metadata buffer for three-dimensional reconstruction (3DR). In some examples, a method for 3DR can include, during a first operational pass, projecting a block (e.g., a voxel) onto a depth frame, performing depth integration on the block to produce an updated block, and storing color integration metadata for the block in a color metadata buffer. The method can also include, during a second operational pass, projecting the updated depth block onto a color frame, and performing color integration on the updated depth block using the color integration metadata to produce an updated depth and color block.

### FIELD

This application is related to image processing. In some examples, aspects of this application relate to systems and techniques for utilizing a color metadata buffer for three-dimensional (3D) reconstruction.

### BACKGROUND

The increasing versatility of digital camera products has allowed digital cameras to be integrated into a wide array of devices and has expanded their use to different applications. For example, phones, drones, cars, computers, televisions, and many other devices today are often equipped with camera devices. The camera devices allow users to capture images and/or video (e.g., including frames of images) from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images.

In recent decades, there has been a demand for 3D content for computer graphics, virtual reality, and communications, triggering a change in emphasis for the requirements. Many existing systems for constructing 3D models are built around specialized hardware resulting in a high cost, which often cannot satisfy the requirements of these new applications. This need has stimulated the use of digital imaging facilities (e.g., cameras) for 3D reconstruction.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for utilizing a color metadata buffer for 3D reconstruction (3DR). According to at least one illustrative example, a method for 3DR of a scene is provided. The method includes: projecting, during a first operational pass, a block of the scene onto a depth frame; performing, during the first operational pass, depth integration on the block to produce an updated depth block; storing, during the first operational pass, color integration metadata for the block in a color metadata buffer; projecting, during a second operational pass, the updated depth block onto a color frame; and performing, during the second operational pass, color integration on the updated depth block using the color integration metadata to produce an updated depth and color block.

In another illustrative example, an apparatus for three-dimensional reconstruction (3DR) of a scene is provided. The apparatus includes a color metadata buffer and at least one processor coupled to the color metadata buffer and configured to: project, during a first operational pass, a block of the scene onto a depth frame; perform, during the first operational pass, depth integration on the block to produce an updated depth block; store, during the first operational pass, color integration metadata for the block in the color metadata buffer; project, during a second operational pass, the updated depth block onto a color frame; and perform, during the second operational pass, color integration on the updated depth block using the color integration metadata to produce an updated depth and color block.

In another illustrative example, a non-transitory computer-readable medium is provided having stored thereon instructions that, when executed by at least one processor, cause the at least one processor to: project, during a first operational pass, a block of the scene onto a depth frame; perform, during the first operational pass, depth integration on the block to produce an updated depth block; store, during the first operational pass, color integration metadata for the block in a color metadata buffer; project, during a second operational pass, the updated depth block onto a color frame; and perform, during the second operational pass, color integration on the updated depth block using the color integration metadata to produce an updated depth and color block.

In another illustrative example, an apparatus for three-dimensional reconstruction (3DR) of a scene is provided. The apparatus includes: means for projecting, during a first operational pass, a block of the scene onto a depth frame; means for performing, during the first operational pass, depth integration on the block to produce an updated depth block; means for storing, during the first operational pass, color integration metadata for the block in a color metadata buffer; means for projecting, during a second operational pass, the updated depth block onto a color frame; and means for performing, during the second operational pass, color integration on the updated depth block using the color integration metadata to produce an updated depth and color block

Aspects generally include a method, apparatus, system, computer program product, non-transitory computer-readable medium, user device, user equipment, wireless communication device, and/or processing system as substantially described with reference to and as illustrated by the drawings and specification.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Examples of various implementations are described in detail below with reference to the following figures:

FIG. 1 is a block diagram illustrating an example architecture of an image capture and processing system, in accordance with some examples.

FIG. 2 is a block diagram illustrating an example of interactions between components of an image capture and processing system, in accordance with some examples.

FIG. 3 is a block diagram illustrating an example device that may employ a color metadata buffer for 3D reconstruction, in accordance with some examples.

FIG. 4 is a diagram illustrating an example of a 3D surface reconstruction of a scene modeled as a volume grid, in accordance with some examples.

FIG. 5 is a diagram illustrating an example of a hash mapping function for indexing blocks (e.g., voxels) in a volume grid, in accordance with some examples.

FIG. 6 is a diagram illustrating an example of a block (e.g., a voxel), in accordance with some examples.

FIG. 7 is a diagram illustrating an example of a truncated signed distance function (TSDF) volume reconstruction, in accordance with some examples.

FIG. 8 is a diagram illustrating an example of 3DR, where the depth integration and color integration processes are performed together, in accordance with some examples.

FIG. 9 is a diagram illustrating an example of 3DR, where the depth integration and color integration processes are performed as two separate independent passes and a 3DR color metadata buffer is employed, in accordance with some examples.

FIG. 10 is a flow diagram illustrating an example of a process employing a color metadata buffer for 3D reconstruction, in accordance with some examples.

FIG. 11 is a diagram illustrating an example of a system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras can be configured with a variety of image capture and image processing operations and settings. The different settings result in images with different appearances. Some camera operations are determined and applied before or during capture of the image, such as automatic exposure control (AEC) and automatic white balance (AWB) processing. Additional camera operations applied before, during, or after capture of an image include operations involving zoom (e.g., zooming in or out), ISO, aperture size, f/stop, shutter speed, and gain. Other camera operations can configure post-processing of an image, such as alterations to contrast, brightness, saturation, sharpness, levels, curves, or colors.

As previously mentioned, in recent decades, there has been a demand for three-dimensional (3D) content for computer graphics, virtual reality, and communications, triggering a change in emphasis for the requirements. Many existing systems for constructing 3D models are built around specialized hardware resulting in a high cost, and often cannot satisfy the requirements of these new applications. The requirements have stimulated the use of digital imaging (e.g., using images from cameras) for 3D reconstruction.

In some cases, volume blocks (e.g., voxels) can be utilized to reconstruct a 3D scene from two-dimensional (2D) images, such as stereo images obtained from a stereo camera. A voxel represents a value on a regular grid in 3D space. As with pixels in a 2D bitmap, voxels do not have their position (e.g., coordinates) explicitly encoded within their values. Instead, rendering systems infer the position of a voxel based upon its position relative to other voxels (e.g., its position in the data structure that makes up a single volumetric image).

In some examples, a system can perform 3D reconstruction (3DR) using depth frames and an associated live camera pose estimate for 3D scene reconstruction. In 3D surface reconstruction, the system can model the scene as a 3D sparse volumetric representation (e.g., referred to as a volume grid). The volume grid can contain a set of voxel blocks, which are each indexed by their position in space with a sparse data representation (e.g., only storing blocks that surround an object and/or obstacle).

In one illustrative example, a system can perform 3DR to reconstruct a 3D scene from 2D depth frames and color frames. The system can divide the scene into 3D blocks (e.g., voxels or voxel blocks, as noted previously). For example, the system may project each voxel onto a 2D depth frame and a 2D color frame to determine the depth and color of the voxel. Once all of the voxels that refer to (e.g., are associated with) this depth frame and color frame are updated accordingly, the process can repeat for a new depth frame and color frame pair or set.

In some cases, a 3DR integration function can be utilized for 3D reconstruction of a scene. In one or more examples, the 3DR integration function can first project a 3D voxel onto a depth frame. Using the corresponding depth values from the depth frame, the position of the voxel in the 3D scene can be determined (e.g., calculated), and whether or not the voxel should be colored can be determined (e.g., calculated). Whether or not the voxel should be colored can be coded within color metadata. The voxel can then be projected onto a color frame. Using corresponding color values from the color frame and the color metadata, the color of the voxel can be determined (e.g., calculated).

Due to resulting long memory (e.g., double data rate (DDR)/main memory) access times, the depth frame and color frame need to be prefetched and cached within a 3D reconstruction engine to decrease the memory (e.g., DDR) access latency and to meet performance targets. Large memory (e.g., random access memories (RAMs)) are needed to cache both the depth frame and color frame. Such large memory (e.g., RAM) requires a large chip (e.g., a system on a chip or SoC) area and high cost. As such, an improved technique for 3D reconstruction from 2D images can be useful.

Accordingly, systems, apparatuses, processes (also referred to as methods), and computer-readable media (collectively referred to herein as “systems and techniques”) are described herein for providing a color metadata buffer for 3D reconstruction (3DR). For instance, in some examples, the systems and techniques provide a 3DR color metadata buffer in a memory (e.g., DDR/main memory) to store the color metadata. DDR will be used herein as an example of the memory for illustrative purposes. However, other types of memory can be used. The addition of the color metadata buffer can allow for the depth integration and color integration processes to be separated into two separate independent passes (e.g., a first pass and a second pass) within the 3DR. In one or more examples, in the first pass, depth integration can be performed for blocks (e.g., 3D blocks, such as 3D voxels), such as all of the blocks (e.g., all of the 3D voxels), that refer to the depth frame and color frame set. Also, in this first pass, the determined color metadata can be stored within (e.g., written to) a color metadata buffer. In some cases, in the first pass, only the depth frame may be prefetched and cached in a 3D reconstruction engine. A separate memory (e.g., one or more RAMs) may be utilized to cache the depth frame (e.g., utilized as a depth cache).

In the second pass, the color metadata buffer can be read in order to perform color integration on all of the blocks (e.g., voxels) that were updated within the first pass. In this second pass, the color frame (e.g., only the color frame) may be prefetched and cached in the 3D reconstruction engine. The same separate memory (e.g., one or more RAMs) that was utilized for the depth cache may be utilized to cache the color frame (e.g., utilized as a color cache).

The addition of the 3DR color metadata buffer to the 3DR dataflow allows for a reduction in the size of the required chip area for the separate memory (e.g., the required RAM size can be decreased by half), as compared to the current designs, to perform the 3DR depth and color integration.

Further aspects of the systems and techniques are described with respect to the figures.

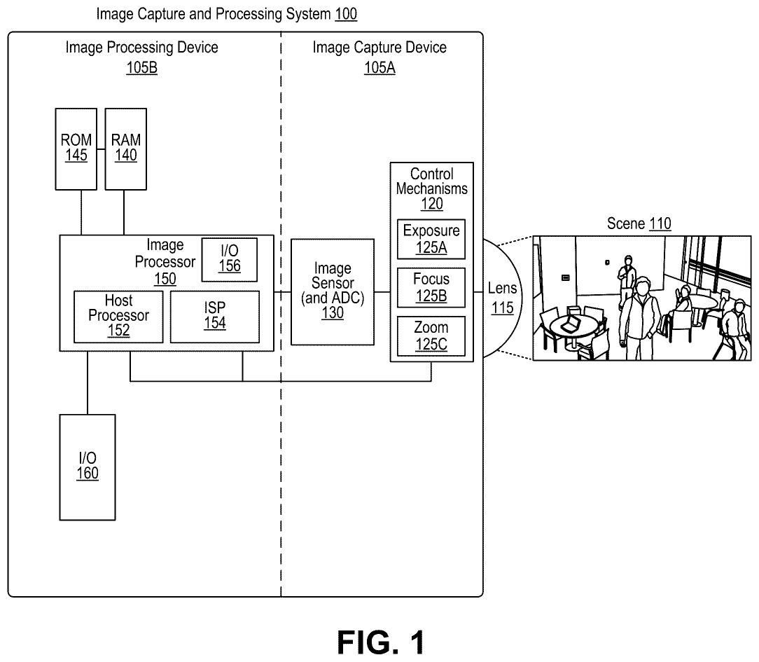

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the device 105A, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1110 discussed with respect to the computing system 1100. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1120, read-only memory (ROM) 145/1125, a cache 1112, a memory unit 1115, another storage device 1130, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1135, any other input devices 1145, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the device 105B and one or more peripheral devices, over which the device 105B may receive data from the one or more peripheral device and/or transmit data to the one or more peripheral devices. The I/O 160 may include one or more wireless transceivers that enable a wireless connection between the device 105B and one or more peripheral devices, over which the device 105B may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames.

In some examples, the host processor 152 can perform electronic image stabilization (EIS). For instance, the host processor 152 can determine a motion vector corresponding to motion compensation for one or more image frames. In some aspects, host processor 152 can position a cropped pixel array (“the image window”) within the total array of pixels. The image window can include the pixels that are used to capture images. In some examples, the image window can include all of the pixels in the sensor, except for a portion of the rows and columns at the periphery of the sensor. In some cases, the image window can be in the center of the sensor while the image capture device 105A is stationary. In some aspects, the peripheral pixels can surround the pixels of the image window and form a set of buffer pixel rows and buffer pixel columns around the image window. Host processor 152 can implement EIS and shift the image window from frame to frame of video, so that the image window tracks the same scene over successive frames (e.g., assuming that the subject does not move). In some examples in which the subject moves, host processor 152 can determine that the scene has changed.

In some examples, the image window can include at least 95% (e.g., 95% to 99%) of the pixels on the sensor. The first region of interest (ROI) (e.g., used for AE and/or AWB) may include the image data within the field of view of at least 95% (e.g., 95% to 99%) of the plurality of imaging pixels in the image sensor 130 of the image capture device 105A. In some aspects, a number of buffer pixels at the periphery of the sensor (outside of the image window) can be reserved as a buffer to allow the image window to shift to compensate for jitter. In some cases, the image window can be moved so that the subject remains at the same location within the adjusted image window, even though light from the subject may impinge on a different region of the sensor. In another example, the buffer pixels can include the ten topmost rows, ten bottommost rows, ten leftmost columns and ten rightmost columns of pixels on the sensor. In some configurations, the buffer pixels are not used for AF, AE or AWB when the image capture device 105A is stationary and the buffer pixels not included in the image output. If jitter moves the sensor to the left by twice the width of a column of pixels between frames, the EIS algorithm can be used to shift the image window to the right by two columns of pixels, so the captured image shows the same scene in the next frame as in the current frame. Host processor 152 can use EIS to smoothen the transition from one frame to the next.

In some aspects, the host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. The settings of different modules of the ISP 154 can be configured by the host processor 152. Each module may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image capture and processing system 100 may perform one or more of the image processing functionalities described above automatically. For instance, one or more of the control mechanisms 120 may be configured to perform auto-focus operations, auto-exposure operations, and/or auto-white-balance operations. In some embodiments, an auto-focus functionality allows the image capture device 105A to focus automatically prior to capturing the desired image. Various auto-focus technologies exist. For instance, active autofocus technologies determine a range between a camera and a subject of the image via a range sensor of the camera, typically by emitting infrared lasers or ultrasound signals and receiving reflections of those signals. In addition, passive auto-focus technologies use a camera's own image sensor to focus the camera, and thus do not require additional sensors to be integrated into the camera. Passive AF techniques include Contrast Detection Auto Focus (CDAF), Phase Detection Auto Focus (PDAF), and in some cases hybrid systems that use both. The image capture and processing system 100 may be equipped with these or any additional type of auto-focus technology.

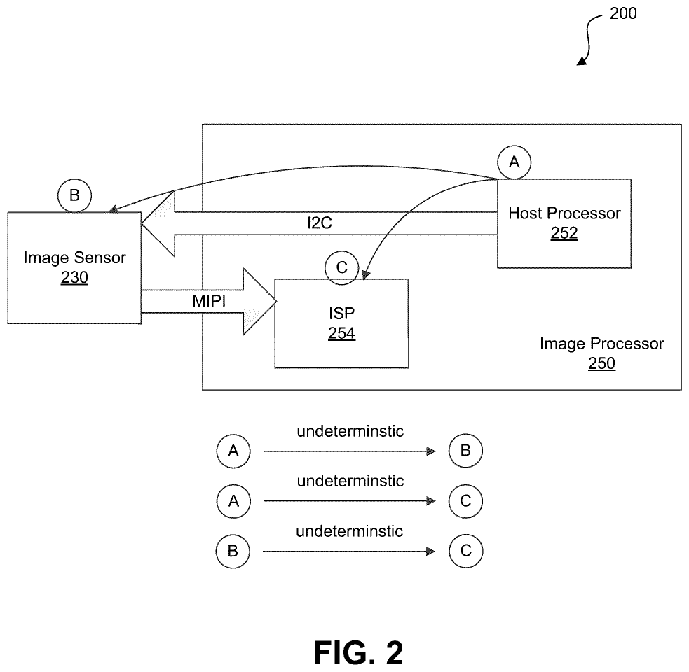

Synchronization between the image sensor 130 and the ISP 154 is important in order to provide an operational image capture system that generates high quality images without interruption and/or failure. FIG. 2 is a block diagram illustrating an example of an image capture and processing system 200 including an image processor 250 (including host processor 252 and ISP 254) in communication with an image sensor 230. The configuration shown in FIG. 2 is illustrative of traditional synchronization techniques used in camera systems. In general, the host processor 252 attempts to provide synchronization between the image sensor 230 and the ISP 254 using fixed periods of time by separately communicating with the image sensor 230 and the ISP 254. For example, in traditional camera systems, the host processor 252 communicates with the image sensor 230 (e.g., over an I2C port) and programs the image sensor 230 parameters with a first fixed period of time, such as 2-frame periods ahead of when that image frame will be processed by the ISP 254. The host processor 252 communicates with the ISP 254 (e.g., over an internal AHB bus or other interface) and programs the ISP 254 parameter settings with a second fixed period of time, such as 1-frame period ahead of when that image frame will be processed by the ISP 254.

The image sensor 230 can send image frames to the ISP 254 (B-to-C in FIG. 2), such as over an MIPI CSI-2 PHY port or interface, or other suitable interface. However, the communication between the host processor 252 and the image sensor 230 (shown as from A to B) is undeterministic. Similarly, the communication between the image sensor 230 and the ISP 254 (shown as from B to C) and the communication the host processor 252 and the ISP 254 (shown as from A to C) are also undeterministic. For example, there can be varying latencies in programming of the image sensor 230 and the ISP 254 by the host processor 252, which can result in a parameter settings mismatch between the sensor and the ISP. The latencies can be due to high CPU usage, congestion in one or more I/O ports, and/or due to other factors.

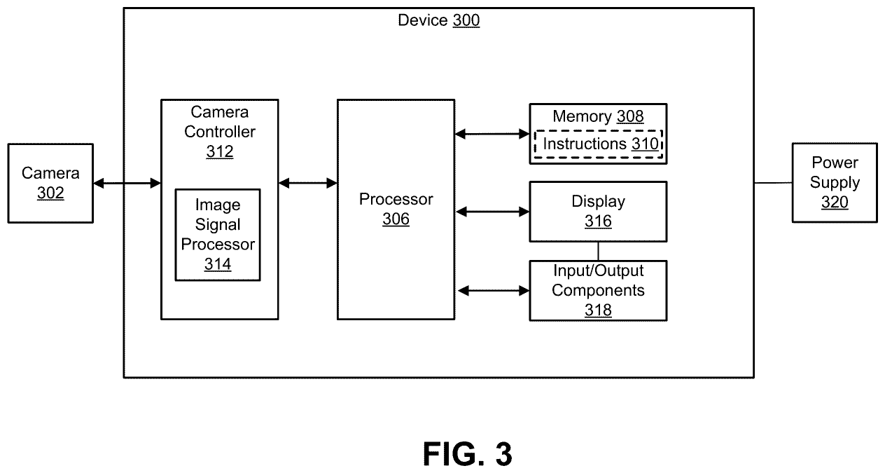

FIG. 3 is a block diagram of an example device 300 that may employ a color metadata buffer for 3D reconstruction. Device 300 may include or may be coupled to a camera 302, and may further include a processor 306, a memory 308 storing instructions 310, a camera controller 312, a display 316, and a number of input/output (I/O) components 318 including one or more microphones (not shown). The example device 300 may be any suitable device capable of capturing and/or storing images or video including, for example, wired and wireless communication devices (such as camera phones, smartphones, tablets, security systems, smart home devices, connected home devices, surveillance devices, internet protocol (IP) devices, dash cameras, laptop computers, desktop computers, automobiles, drones, aircraft, and so on), digital cameras (including still cameras, video cameras, and so on), or any other suitable device. The device 300 may include additional features or components not shown. For example, a wireless interface, which may include a number of transceivers and a baseband processor, may be included for a wireless communication device. Device 300 may include or may be coupled to additional cameras other than the camera 302. The disclosure should not be limited to any specific examples or illustrations, including the example device 300.

Camera 302 may be capable of capturing individual image frames (such as still images) and/or capturing video (such as a succession of captured image frames). Camera 302 may include one or more image sensors (not shown for simplicity) and shutters for capturing an image frame and providing the captured image frame to camera controller 312. Although a single camera 302 is shown, any number of cameras or camera components may be included and/or coupled to device 300. For example, the number of cameras may be increased to achieve greater depth determining capabilities or better resolution for a given FOV.

Memory 308 may be a non-transient or non-transitory computer readable medium storing computer-executable instructions 310 to perform all or a portion of one or more operations described in this disclosure. Device 300 may also include a power supply 320, which may be coupled to or integrated into the device 300.

Processor 306 may be one or more suitable processors capable of executing scripts or instructions of one or more software programs (such as the instructions 310) stored within memory 308. In some aspects, processor 306 may be one or more general purpose processors that execute instructions 310 to cause device 300 to perform any number of functions or operations. In additional or alternative aspects, processor 306 may include integrated circuits or other hardware to perform functions or operations without the use of software. While shown to be coupled to each other via processor 306 in the example of FIG. 3, processor 306, memory 308, camera controller 312, display 316, and I/O components 318 may be coupled to one another in various arrangements. For example, processor 306, memory 308, camera controller 312, display 316, and/or I/O components 318 may be coupled to each other via one or more local buses (not shown for simplicity).

Display 316 may be any suitable display or screen allowing for user interaction and/or to present items (such as captured images and/or videos) for viewing by the user. In some aspects, display 316 may be a touch-sensitive display. Display 316 may be part of or external to device 300. Display 316 may comprise an LCD, LED, OLED, or similar display. I/O components 318 may be or may include any suitable mechanism or interface to receive input (such as commands) from the user and/or to provide output to the user. For example, I/O components 318 may include (but are not limited to) a graphical user interface, keyboard, mouse, microphone and speakers, and so on.

Camera controller 312 may include an image signal processor (ISP) 314, which may be (or may include) one or more image signal processors to process captured image frames or videos provided by camera 302. For example, ISP 314 may be configured to perform various processing operations for automatic focus (AF), automatic white balance (AWB), and/or automatic exposure (AE), which may also be referred to as automatic exposure control (AEC). Examples of image processing operations include, but are not limited to, cropping, scaling (e.g., to a different resolution), image stitching, image format conversion, color interpolation, image interpolation, color processing, image filtering (e.g., spatial image filtering), and/or the like.

In some example implementations, camera controller 312 (such as the ISP 314) may implement various functionality, including imaging processing and/or control operation of camera 302. In some aspects, ISP 314 may execute instructions from a memory (such as instructions 310 stored in memory 308 or instructions stored in a separate memory coupled to ISP 314) to control image processing and/or operation of camera 302. In other aspects, ISP 314 may include specific hardware to control image processing and/or operation of camera 302. ISP 314 may alternatively or additionally include a combination of specific hardware and the ability to execute software instructions.

While not shown in FIG. 3, in some implementations, ISP 314 and/or camera controller 312 may include an AF module, an AWB module, and/or an AE module. ISP 314 and/or camera controller 312 may be configured to execute an AF process, an AWB process, and/or an AE process. In some examples, ISP 314 and/or camera controller 312 may include hardware-specific circuits (e.g., an application-specific integrated circuit (ASIC)) configured to perform the AF, AWB, and/or AE processes. In other examples, ISP 314 and/or camera controller 312 may be configured to execute software and/or firmware to perform the AF, AWB, and/or AE processes. When configured in software, code for the AF, AWB, and/or AE processes may be stored in memory (such as instructions 310 stored in memory 308 or instructions stored in a separate memory coupled to ISP 314 and/or camera controller 312). In other examples, ISP 314 and/or camera controller 312 may perform the AF, AWB, and/or AE processes using a combination of hardware, firmware, and/or software. When configured as software, AF, AWB, and/or AE processes may include instructions that configure ISP 314 and/or camera controller 312 to perform various image processing and device managements tasks, including the techniques of this disclosure.

As previously mentioned, recently, there has been a demand for 3D content for computer graphics, virtual reality, and communications, that has triggered a change in emphasis for the requirements. Many existing systems for constructing 3D models are built around specialized hardware that results in a high cost, which often cannot satisfy the requirements of these new applications. This need has stimulated the use of digital imaging facilities (e.g., cameras) for 3D reconstruction.

Currently, volume blocks (e.g., voxels) are often used to reconstruct a 3D scene from 2D images (e.g., stereo images obtained from a stereo camera). A voxel will be used herein as an example of blocks (e.g., 3D blocks). A voxel can represent a value on a regular grid in 3D space. As with pixels in a 2D bitmap, voxels themselves do not have their position (e.g., coordinates) explicitly encoded within their values. Instead, rendering systems infer the position of a voxel based upon its position relative to other voxels (e.g., its position in the data structure that makes up a single volumetric image).

3DR utilizes depth frames with an associated live camera pose estimate for scene reconstruction. In 3D surface reconstruction, the scene can be modeled as a 3D sparse volumetric representation (e.g., that can be referred to as a volume grid). The volume grid contains a set of voxel blocks that are indexed by their position in space with a sparse data representation (e.g., only storing blocks that surround an object and/or obstacle). For example, a room with a size of four meters (m) by four m by five m may be modeled with a volume grid having a total of 1.25 million (M) voxel blocks, where each voxel block has a four centimeter block dimension. In some examples, for this room, the occupied voxel blocks may only be about ten to fifteen percent.

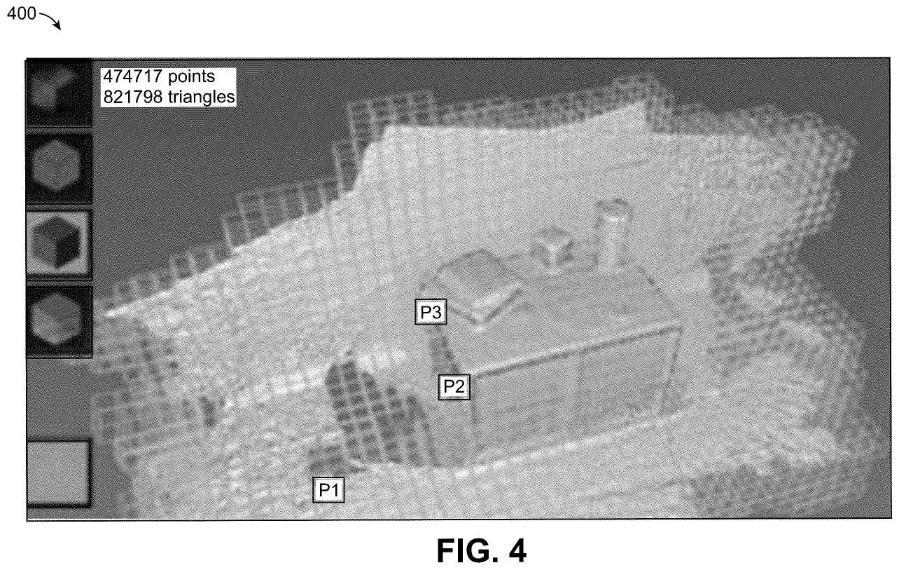

FIG. 4 shows an example of a scene that has been modeled as a 3D sparse volumetric representation for 3DR. In particular, FIG. 4 is a diagram illustrating an example of a 3D surface reconstruction 400 of a scene modeled with an overlay of a volume grid containing voxel blocks. For 3DR, a camera (e.g., a stereo camera) may take photos of the scene from various different view points and angles. For example, a camera may take a photo of the scene when the camera is located at position P1. Once multiple photos have been taken of the scene, a 3D representation of the scene can be constructed by modeling the scene as a volume grid with 3D blocks (e.g., voxel blocks).

In one or more examples, an image (e.g., a photo) of a 3D block (e.g., voxel) located at point P2 within the scene may be taken by a camera (e.g., a stereo camera) located at point P1 with a certain camera pose (e.g., at a certain angle). The camera can capture both depth and color. From this image, it can be determined that there is an object located at point P2 with a certain depth and, as such, there is a surface. As such, it can be determined that there is an object that maps to this particular 3D block. An image of a 3D block located at point P3 within the scene may be taken by the same camera located at the point P1 with a different camera pose (e.g., with a different angle). From this image, it can be determined that there is an object located at point P3 with a certain depth and having a surface. As such, it can be determined that there is an object that maps to this particular 3D block (e.g., voxel). An integrate process can occur where all of the blocks within the scene are passed through an integrate function. The integrate function can determine depth information for each of the blocks from the depth frame and can update each block to indicate whether the block has a surface or not. The blocks that are determined to have a surface can then be updated with a color.

In one or more examples, the pose of the camera can indicate the location of the camera (e.g., which may be indicated by location coordinates X, Y) and the angle that the camera (e.g., which is the angle that the camera is positioned in for capturing the image). Each block (e.g., the block located at point P2) has a location (e.g., which may be indicated by location coordinates X, Y, Z). The pose of the camera and the location of each block can be used to map each block to world coordinates for the whole scene.

In one or more examples, to achieve fast multiple access to 3D blocks (e.g., voxels), instead of using a large memory lookup table, various different volume block representations may be used to index the blocks in the 3D scene to store data where the measurements are observed. Volume block representations that may be employed can include, but are not limited to, a hash map lookup, an octree, and a large blocks implementation.

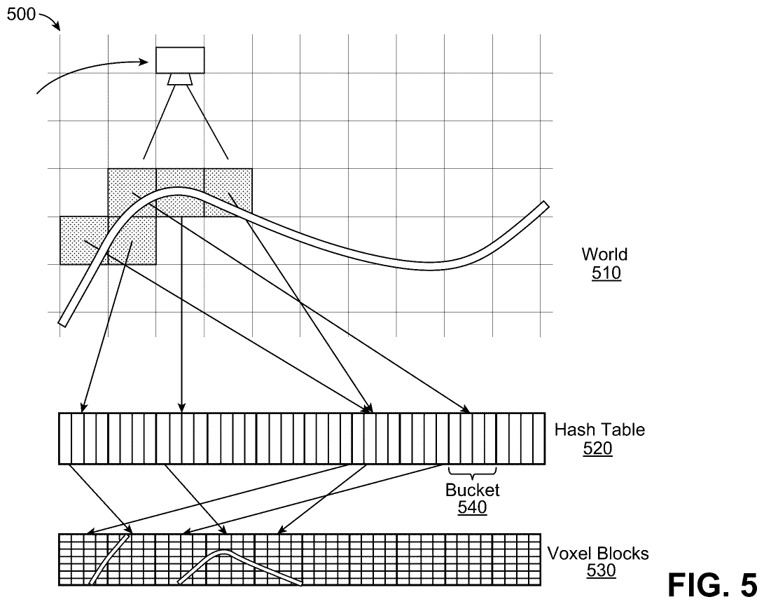

FIG. 5 shows an example of a hash map lookup type of volume block representation. In particular, FIG. 5 is a diagram illustrating an example of a hash mapping function 500 for indexing voxel blocks 530 in a volume grid. In FIG. 5, a volume grid is shown with world coordinates 510. Also shown in FIG. 5 are a hash table 520 and voxel blocks 530. In one or more examples, a hash function can be used to map the integer world coordinates 510 into hash buckets 540 within the hash table 520. The hash buckets 540 can each store a small array of points to regular grid voxels blocks 530. Each voxel block 530 contains data that can be used for depth integration.

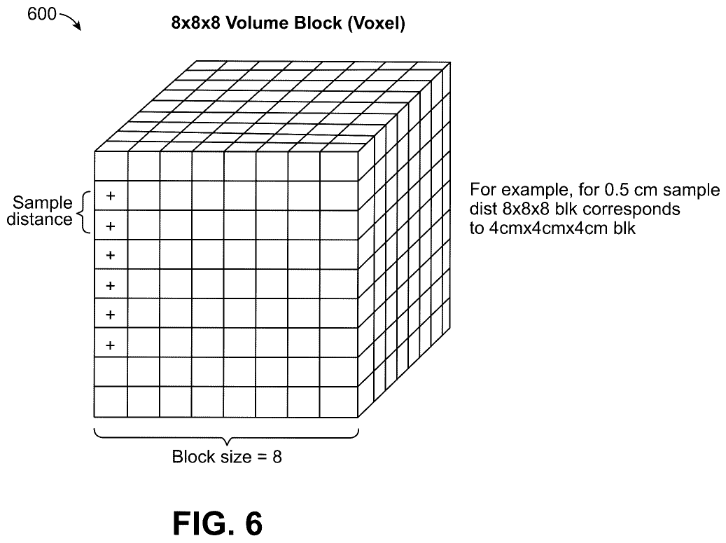

FIG. 6 is a diagram illustrating an example of a volume block (e.g., a voxel) 600. In FIG. 6, the voxel 600 is shown to have a block size of eight. For example, a 0.5 centimeter (cm) sample distance for an eight by eight by eight voxel can correspond to a four cm by four cm by four cm voxel.

In one or more examples, each voxel (e.g., voxel 600) can contain truncated signed distance function (TSDF) samples, a RGB, and a weight. TSDF is a function that measures the distance d of each pixel from the surface of an object to the camera. A voxel with a positive value for d can indicate that the voxel is located in front of a surface, a voxel with a negative value for d can indicate that the voxel is located inside (or behind) the surface, and a voxel with a zero value for d can indicate that the voxel is located on the surface. The distance d is truncated to [−1, 1], such that:

$$tsdf = \{ \begin{matrix}- 1 , & if d \leq - ramp \\ \frac{d}{ramp} , & if - ramp < d < ramp \\ 1 , & if d \geq ramp\end{matrix} \}$$

$$samples \cdot tsdf = ( \frac{sample \cdot weight * sample \cdot tsdf + tsdf}{sample \cdot weight + 1} )$$

A TSDF integration or fusion process can be employed that updates the TSDF values and weights with each new observation from the sensor (e.g., camera).

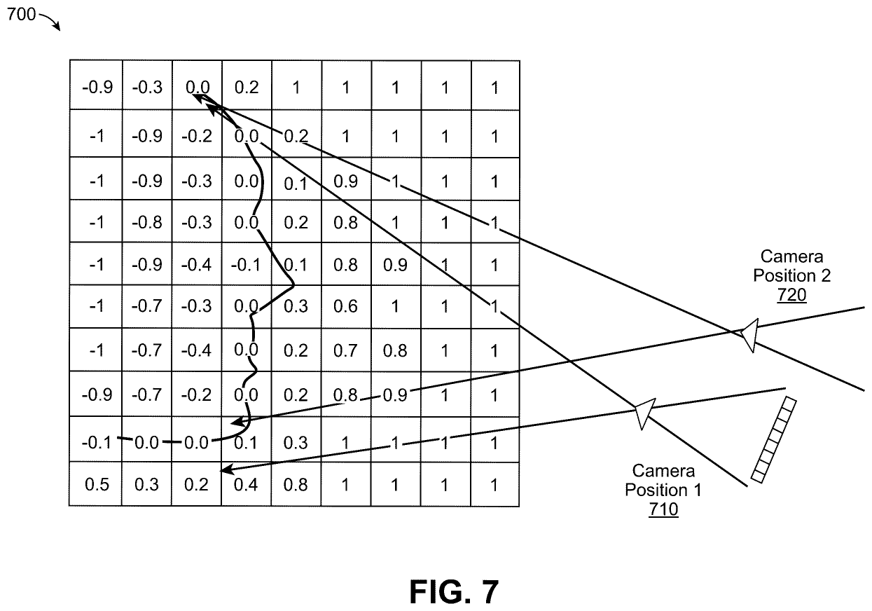

FIG. 7 is a diagram illustrating an example of a TSDF volume reconstruction 700. In FIG. 7, a voxel grid including a plurality of voxels is shown. A camera is shown to be obtaining images of a scene (e.g., person's face) from two different camera positions (e.g., camera position 1 710 and camera position 2 720). During operation for TSDF, for each new observation (e.g., image) from the camera (e.g., for each image taken by the camera at a different camera position), the distance (d) of a corresponding pixel of each voxel within the voxel grid can be obtained. The distance (d) can be subtracted from the distance of the voxel itself, and that result can be divided by a truncation threshold value threshold. The TSDF values (and color values) can be updated in the global memory. In FIG. 7, the voxels with positive values are shown to be located in front of the person's face, the voxels with negative values are shown to be located inside of the person's face, and the voxels with zero values are shown to be located on the surface of the person's face.

As previously mentioned, in 3DR, a 3D scene can be reconstructed from 2D depth frames and color frames. To accomplish this reconstruction, the scene may be divided into 3D blocks (e.g., voxels). Each voxel can be projected onto a 2D depth frame and a 2D color frame to determine the voxel's depth and color. Once all of the voxels for the depth frame and color frame are updated accordingly, the process can be repeated for a new depth frame and color frame set. Due to long DDR/main memory access times, the depth frame and color frame need to be prefetched and cached within a 3D reconstruction engine to decrease the DDR access latency and meet performance targets. Due to long DDR/main memory access times, the depth frame and color frame need to be prefetched and cached within a 3D reconstruction engine to decrease the DDR access latency and meet performance targets. Large RAMs are required to cache both the depth and color frames. These large RAMs need a large chip (e.g., system on a chip) area that results in a high cost.

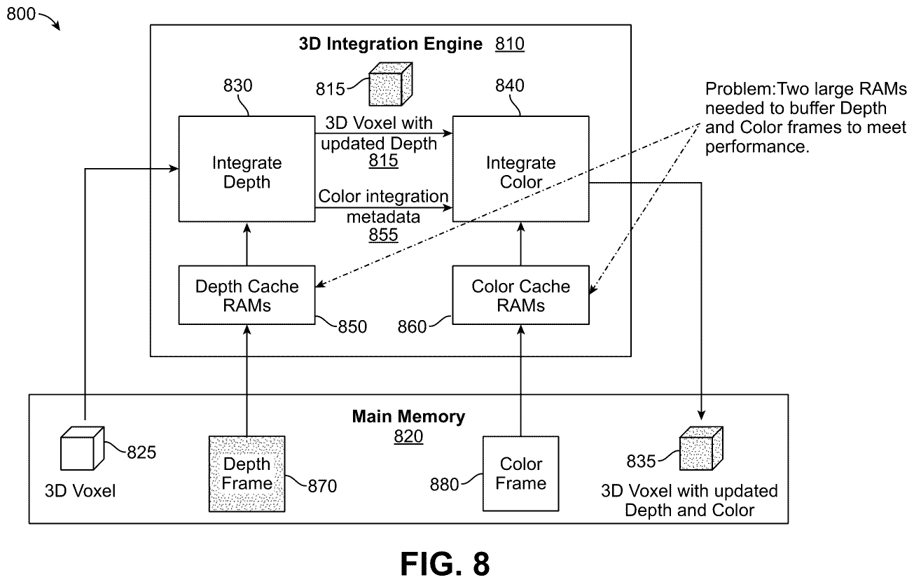

FIG. 8 shows an example of 3DR that utilizes large RAMs to cache the depth and color frames. In particular, FIG. 8 is a diagram illustrating an example of 3DR 800, where the depth integration and color integration processes are performed together. In FIG. 8, a 3D integration engine 810 and a main memory 820 (e.g., DDR) are shown. In one or more examples, the 3D integration engine 810 of FIG. 8 may be located within the ISP 154 of FIG. 1, ISP 254 of FIG. 2, and/or the ISP 314 of FIG. 3. In some examples, the main memory 820 of FIG. 8 may be located within the ISP 154, ROM 145, and/or RAM 140 of FIG. 1; the ISP 254 of FIG. 2; and/or the ISP 314 and/or the memory 308 of FIG. 3.

In FIG. 8, the 3D integration engine 810 is shown to include an integrate depth engine 830, an integrate color engine 840, a depth cache RAMs 850, and a color cache RAMs 860. The main memory 820 is shown to include a depth frame 870 and a color frame 880. For the 3DR 800, a 3D voxel 825 can be passed through an integrate function to produce a 3D voxel with an updated depth and color 835.

In one or more examples, during operation of the 3DR 800, the 3D voxel 825 can be projected onto the depth frame 870. After the 3D voxel 825 is projected onto the depth frame 870, the integrate depth engine 830 can determine a depth value for the 3D voxel 825. The integrate depth engine 830 can update the 3D voxel 825 with an updated depth to produce a 3D voxel with an updated depth 815.

From the depth value, the integrate depth engine 830 can determine whether or not the 3D voxel 825 is located on the surface of an object and/or obstruction. If the integrate depth engine 830 determines that the 3D voxel 825 is located on a surface, then the 3D voxel 825 can be updated (e.g., by the integrate color engine 840) with a color. The integrate depth engine 830 can code the color determination for the 3D voxel 825 (e.g., code whether or not the 3D voxel 825 should be updated with color) within color integration metadata 855.

The 3D voxel with an updated depth 815 and the color integration metadata 855 can be passed from the integrate depth engine 830 to the integrate color engine 840. If (e.g., according to the color integration metadata 855) the 3D voxel 825 should be updated with color (e.g., when the 3D voxel 825 is located on a surface), then the 3D voxel with updated depth 815 can be projected onto the color frame 880. After the 3D voxel with updated depth 815 is projected onto the color frame 880, the integrate color engine 840 can determine color for the 3D voxel 825. The integrate color engine 840 can then update the 3D voxel 825 with updated depth 815 with color to output a 3D voxel with updated depth and color 835.

Since the 3DR 800 has long main memory 820 (e.g., DDR) access times, the depth frame 870 and color frame 880 need to be prefetched and cached within depth cache RAMs 850 and color cache RAMs 860, respectively, within the 3D integration engine 810 to decrease the DDR access latency to meet performance targets. Large depth cache RAMs 850 and color cache RAMs 860 are needed to cache both the depth frame 870 and the color frame 880. These large depth cache RAMs 850 and color cache RAMs 860 require a large chip (e.g., system on a chip) area and a high cost. As such, an improved technique for 3D reconstruction from 2D images can be beneficial.

In one or more aspects, systems and techniques are provided that employ a color metadata buffer for 3D reconstruction. In particular, the systems and techniques provide a 3DR color metadata buffer in the DDR/main memory to store the color metadata. The addition of this buffer can allow for the depth integration and color integration processes to be separated into two separate independent passes (e.g., a first pass and a second pass) within the 3DR. In one or more examples, in the first pass, depth integration may be performed for all of the 3D voxels that refer to the depth frame and color frame set. Also in this first pass, the determined color metadata may be stored (e.g., written) within a color metadata buffer. In this first pass, only the depth frame can be prefetched and cached in a 3D reconstruction engine. RAMs can be utilized to cache the depth frame (e.g., utilized as a depth cache).

In the second pass, the color metadata buffer may be read in order to perform color integration on all of the voxels that were updated within the first pass. In this second pass, only the color frame can be prefetched and cached in the 3D reconstruction engine. The same RAMs that were utilized for the depth cache can be utilized to cache the color frame (e.g., utilized as a color cache). The addition of the 3DR color metadata buffer to the 3DR dataflow can allow for a reduction in the size of the required chip area for the RAMs (e.g., the required RAM size, on the system on a chip, can be decreased by half), as compared to the current designs, to perform the 3DR depth and color integration.

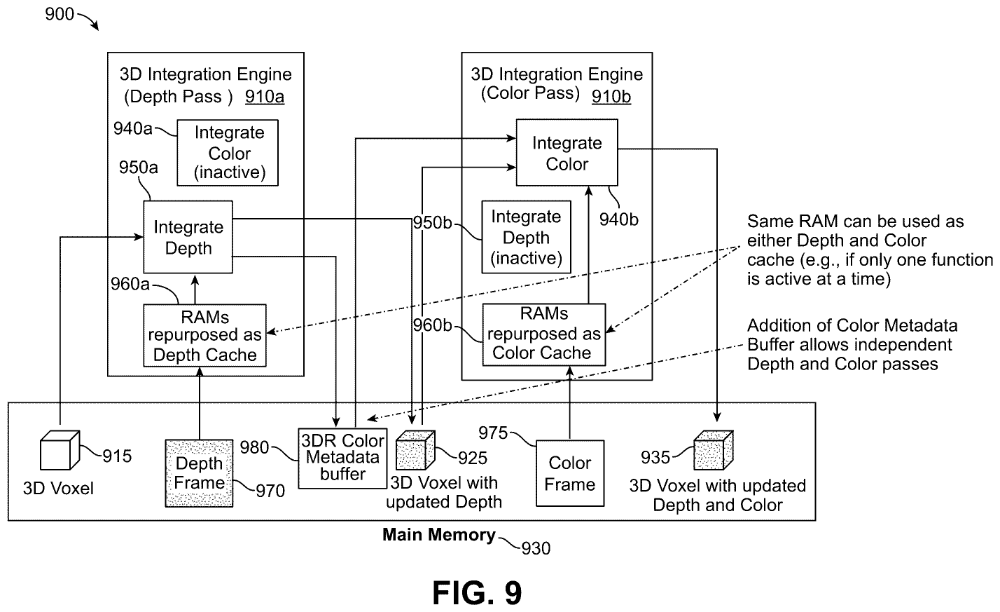

FIG. 9 shows an example of a system that employs a color metadata buffer for 3D reconstruction. In particular, FIG. 9 is a diagram illustrating an example of 3DR 900, where the depth integration and color integration processes are performed by a 3D integration engine 910a, 910b as two separate independent passes (e.g., a first pass and a second pass, where the first pass is performed prior to the second pass) and a 3DR color metadata buffer 980 is employed. In FIG. 9, the 3D integration engine 910a, 910b (e.g., employed for both a depth pass and a color pass) and a main memory 930 (e.g., DDR) are shown. In one or more examples, the 3D integration engine 910a, 910b (employed for both the depth pass and the color pass) of FIG. 9 may be located within the ISP 154 of FIG. 1, ISP 254 of FIG. 2, and/or the ISP 314 of FIG. 3. In some examples, the main memory 820 of FIG. 8 may be located within the ISP 154, ROM 145, and/or RAM 140 of FIG. 1; the ISP 254 of FIG. 2; and/or the ISP 314 and/or the memory 308 of FIG. 3.

In FIG. 9, the 3D integration engine 910a (for the depth pass) is shown to include an integrate depth engine 950a and RAMs 960a (e.g., which can be repurposed as a depth cache). In the 3D integration engine 910a (for the depth pass), an integrate color engine 940a is inactive. The 3D integration engine 910b (for the color pass) is shown to include the same integrate color engine 940b and the same RAMs 960b (e.g., which can be repurposed as a color cache). In the 3D integration engine 910b (for the color pass), the same integrate depth engine 940b is inactive. The main memory 930 is shown to include a depth frame 970, a color frame 975, and a 3DR color metadata buffer 980. For the 3DR 900, a 3D voxel 915 can be passed through an integrate function to produce a 3D voxel with an updated depth and color 935.

In one or more examples, during operation of the 3DR 900, for the first pass (e.g., first operational pass), the 3D voxel 915 can be projected onto the depth frame 970. After the 3D voxel 915 is projected onto the depth frame 970, the integrate depth engine 950a can perform depth integration to determine a depth value for the 3D voxel 915. The integrate depth engine 950a can update the 3D voxel 915 with an updated depth to produce a 3D voxel with an updated depth 925. Since the 3DR 900 has long main memory 930 (e.g., DDR) access times, the depth frame 970 can be prefetched and cached within the one or more RAMs 960a (e.g., which are repurposed as a depth cache for the first pass) to decrease the DDR access latency to meet performance targets.

From the depth value, the integrate depth engine 950a can determine whether or not the 3D voxel 915 is located on the surface of an object and/or obstruction. If the integrate depth engine 950a determines that the 3D voxel 915 is located on a surface, then the integrate depth engine 950a can determine that the 3D voxel 915 can be updated (e.g., by the integrate color engine 940b) with a color. The integrate depth engine 950a can code the color determination for the 3D voxel 915 (e.g., code whether or not the 3D voxel 915 should be updated with color) within color integration metadata that can be stored within the 3DR color metadata buffer 980. In one or more examples, the color integration metadata can be coded with a single bit to indicate whether or not the 3D voxel 925 should be updated with color. For example, the color integration metadata can be coded with a bit of one (1) to indicate that the 3D voxel 925 should be updated with color, or the color integration metadata can be coded with a bit of zero (0) to indicate that the 3D voxel 925 should not be updated with color.

For the second pass (e.g., second operational pass), the 3D voxel with an updated depth 925 and the color integration metadata (e.g., which is stored within the 3D color metadata buffer 980) can be passed to the integrate color engine 940b. If (e.g., according to the color integration metadata) the 3D voxel 915 should be updated with color (e.g., when the 3D voxel 915 is located on a surface), then the 3D voxel with updated depth 925 can be projected onto the color frame 975. After the 3D voxel with updated depth 925 is projected onto the color frame 975, the integrate color engine 940b can determine color for the 3D voxel 915. The integrate color engine 940b can then perform color integration to update the 3D voxel with updated depth 925 with color to output a 3D voxel with updated depth and color 935. Since the 3DR 900 has long main memory 930 (e.g., DDR) access times, the color frame 975 can be prefetched and cached within the RAMs 960b (e.g., which are repurposed as a color cache for the second pass) to decrease the DDR access latency and meet performance targets.

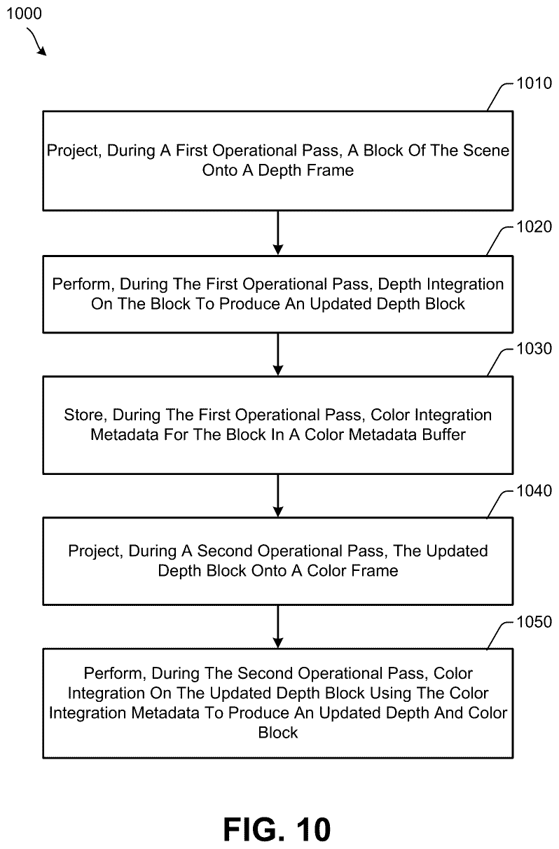

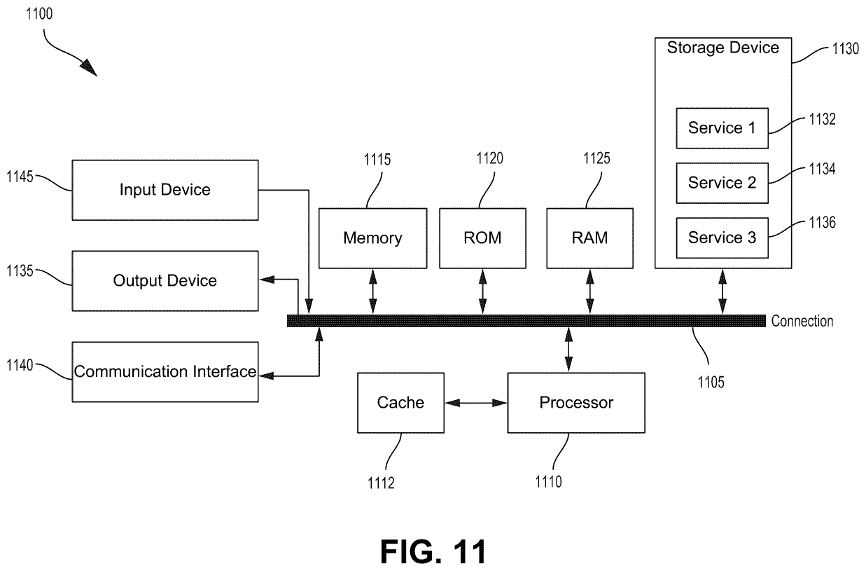

FIG. 10 is a flow chart illustrating an example of a process 1000 employing a color metadata buffer for 3D reconstruction. The process 1000 can be performed by a computing device, or by a component or system (e.g., a chipset) of the computing device. The operations of the process 1000 may be implemented as software components that are executed and run on one or more processors (e.g., processor 1110 of FIG. 11 or other processor(s)).

At block 1010, the device (or component thereof) can project, during a first operational pass, a block of the scene onto a depth frame (e.g., the depth frame 970 of FIG. 9). In some aspects, the device (or component thereof) can prefetch and cache, during the first operational pass, the depth frame into memory (e.g., RAM(s) 960a of FIG. 9). In some examples, the block is a voxel (e.g., the 3D voxel 915 of FIG. 9). In some cases, the scene is modeled as a volume grid including a plurality of blocks (e.g., a plurality of voxels) including the block (e.g., a voxel).

At block 1020, the device (or component thereof) can perform, during the first operational pass, depth integration (e.g., using integrate depth engine 950a of FIG. 9) on the block to produce an updated depth block. In some cases, the device (or component thereof) can determine a depth value for the block during the depth integration. In some aspects, the device (or component thereof) can determine whether the block is located on a surface of one of an object or an obstruction, based on the depth value. In some examples, the device (or component thereof) can determine whether the block can be updated with color, based on determining of whether the block is located on the surface of one of the object or the obstruction.

At block 1030, the device (or component thereof) can store, during the first operational pass, color integration metadata for the block in a color metadata buffer (e.g., 3DR color metadata buffer 980 of FIG. 9). In some aspects, the color integration metadata indicates whether to update the block with color. In one or more examples, the color integration metadata includes a respective single bit of data for each block of a plurality of blocks of the scene, where a first value for a first bit of the color integration metadata corresponding to a first block indicates that the first block is to be updated with color and a second value for the first bit indicates that the first block is not to be updated with color.

At block 1040, the device (or component thereof) can project, during a second operational pass, the updated depth block onto a color frame. In one or more examples, the first operational pass is performed prior to the second operational pass. In some cases, the device (or component thereof) can prefetch and cache, during the second operational pass, the color frame into the memory (e.g., RAM(s) 960a of FIG. 9).

At block 1050, the device (or component thereof) can perform, during the second operational pass, color integration (e.g., using integrate color engine 940b) on the updated depth block using the color integration metadata to produce an updated depth and color block (e.g., 3D voxel 935 with updated depth and color).

In some examples, the process 1000 may be performed by one or more computing devices or apparatuses. In some illustrative examples, the process 1000 can be performed by the image capture and processing system 100 of FIG. 1, the device 300 of FIG. 3, and/or one or more computing devices or systems (e.g., the computing system 1100 of FIG. 11). In some cases, such a computing device or apparatus may include a processor, microprocessor, microcomputer, or other component of a device that is configured to carry out the steps of the process 1000. In some examples, such computing device or apparatus may include one or more sensors configured to capture image data. For example, the computing device can include a smartphone, a head-mounted display, a mobile device, a camera, a tablet computer, or other suitable device. In some examples, such computing device or apparatus may include a camera configured to capture one or more images or videos. In some cases, such computing device may include a display for displaying images. In some examples, the one or more sensors and/or camera are separate from the computing device, in which case the computing device receives the sensed data. Such computing device may further include a network interface configured to communicate data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1000 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1000 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a diagram illustrating an example of a system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1100 includes at least one processing unit (CPU or processor) 1110 and connection 1105 that couples various system components including the memory unit 1115, such as read-only memory (ROM) 1120 and random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some embodiments, a hardware service that performs a particular function can include the software component stored in a computer-readable medium in connection with the necessary hardware components, such as processor 1110, connection 1105, output device 1135, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. A method for three-dimensional reconstruction (3DR) of a scene, the method comprising: projecting, during a first operational pass, a block of the scene onto a depth frame; performing, during the first operational pass, depth integration on the block to produce an updated depth block; storing, during the first operational pass, color integration metadata for the block in a color metadata buffer; projecting, during a second operational pass, the updated depth block onto a color frame; and performing, during the second operational pass, color integration on the updated depth block using the color integration metadata to produce an updated depth and color block.

Aspect 2. The method of Aspect 1, further comprising prefetching and caching, during the first operational pass, the depth frame into memory.

Aspect 3. The method of Aspect 2, further comprising prefetching and caching, during the second operational pass, the color frame into the memory.

Aspect 4. The method of any one of Aspects 1 to 3, wherein the first operational pass is performed prior to the second operational pass.

Aspect 5. The method of any one of Aspects 1 to 4, wherein the color integration metadata indicates whether to update the block with color.

Aspect 6. The method of Aspect 5, wherein the color integration metadata comprises a respective single bit of data for each block of a plurality of blocks of the scene, wherein a first value for a first bit of the color integration metadata corresponding to a first block indicates that the first block is to be updated with color and a second value for the first bit indicates that the first block is not to be updated with color.

Aspect 7. The method of any one of Aspects 1 to 6, wherein the block is a voxel.

Aspect 8. The method of any one of Aspects 1 to 7, wherein the scene is modeled as a volume grid comprising a plurality of blocks comprising the block.

Aspect 9. The method of any one of Aspects 1 to 8, further comprising determining a depth value for the block during the depth integration.

Aspect 10. The method of Aspect 9, further comprising determining whether the block is located on a surface of one of an object or an obstruction, based on the depth value.

Aspect 11. The method of Aspect 10, further comprising determining whether the block can be updated with color, based on determining of whether the block is located on the surface of one of the object or the obstruction.

Aspect 12. An apparatus for three-dimensional reconstruction (3DR) of a scene, the apparatus comprising: a color metadata buffer; and at least one processor coupled to the color metadata buffer and configured to: project, during a first operational pass, a block of the scene onto a depth frame; perform, during the first operational pass, depth integration on the block to produce an updated depth block; store, during the first operational pass, color integration metadata for the block in the color metadata buffer; project, during a second operational pass, the updated depth block onto a color frame; and perform, during the second operational pass, color integration on the updated depth block using the color integration metadata to produce an updated depth and color block.

Aspect 13. The apparatus of Aspect 12, further comprising memory to prefetch and cache, during the first operational pass, the depth frame.

Aspect 14. The apparatus of Aspect 13, wherein the memory is further configured to prefetch and cache, during the second operational pass, the color frame.

Aspect 15. The apparatus of any one of Aspects 12 to 14, wherein the first operational pass is performed prior to the second operational pass.

Aspect 16. The apparatus of any one of Aspects 12 to 15, wherein the color integration metadata indicates whether to update the block with color.

Aspect 17. The apparatus of Aspect 16, wherein the color integration metadata comprises a respective single bit of data for each block of a plurality of blocks of the scene, wherein a first value for a first bit of the color integration metadata corresponding to a first block indicates that the first block is to be updated with color and a second value for the first bit indicates that the first block is not to be updated with color.

Aspect 18. The apparatus of any one of Aspects 12 to 17, wherein the block is a voxel.

Aspect 19. The apparatus of any one of Aspects 12 to 18, wherein the scene is modeled as a volume grid comprising a plurality of blocks comprising the block.

Aspect 20. The apparatus of any one of Aspects 12 to 19, wherein the at least one processor is further configured to determine a depth value for the block during the depth integration.

Aspect 21. The apparatus of Aspect 20, wherein the at least one processor is further configured to determine whether the block is located on a surface of one of an object or an obstruction, based on the depth value.

Aspect 22. The apparatus of Aspect 21, wherein the at least one processor is further configured to determine whether the block can be updated with color, based on determining whether the block is located on the surface of one of the object or the obstruction.

Aspect 23. An apparatus for three-dimensional reconstruction (3DR) of a scene, the apparatus comprising: an integration engine comprising an integrate depth engine configured to perform depth integration on a block to produce an updated depth block; an integrate color engine configured to perform color integration on the updated depth block using color integration metadata to produce an updated depth and color block; and a main memory comprising a depth frame to project the block onto; a color metadata buffer to store the color integration metadata, and a color frame to project the updated depth block onto.

Aspect 24. The apparatus of Aspect 23, wherein the integrate depth engine is configured to perform the depth integration during a first operational pass.

Aspect 25. The apparatus of Aspect 23, wherein the integrate color engine is configured to perform the color integration during a second operational pass.

Aspect 26. The apparatus of Aspect 23, wherein the block is projected onto the depth frame during a first operational pass.

Aspect 27. The apparatus of Aspect 23, wherein the updated depth block is projected onto the color frame during a second operational pass.

Aspect 28. The apparatus of Aspect 23, wherein the color metadata buffer is configured to store the color integration metadata during a first operational pass.

Aspect 29. The apparatus of Aspect 23, wherein the integration engine further comprises a memory to prefetch and cache, during a first operational pass, the depth frame.

Aspect 30. The apparatus of Aspect 29, wherein the memory is further configured to prefetch and cache, during a second operational pass, the color frame.

Aspect 31. A method of three-dimensional reconstruction (3DR) of a scene, the method comprising: performing depth integration on a block to produce an updated depth block; performing color integration on the updated depth block using color integration metadata to produce an updated depth and color block; projecting the block onto a depth frame in a main memory; storing the color integration metadata in a color metadata buffer; and projecting the updated depth block onto a color frame.

Aspect 32. The method of Aspect 31, further comprising performing the depth integration during a first operational pass.

Aspect 33. The method of Aspect 31, further comprising performing the color integration during a second operational pass.

Aspect 34. The method of Aspect 31, further comprising projecting the block onto the depth frame during a first operational pass.

Aspect 35. The method of Aspect 31, further comprising projecting the updated depth block onto the color frame during a method operational pass.

Aspect 36. The apparatus of Aspect 31, further comprising storing the color integration metadata in the color metadata buffer during a first operational pass.

Aspect 37. The method of Aspect 31, further comprising prefetching and caching, during a first operational pass, the depth frame.

Aspect 38. The method of Aspect 37, further comprising prefetching and caching, during a second operational pass, the color frame.

Aspect 39. A non-transitory computer-readable medium having stored thereon instructions that, when executed by at least one processor, cause the at least one processor to perform operations according to any of Aspects 1 to 11.

Aspect 40. An apparatus for wireless communications, comprising one or more means for performing operations according to any of Aspects 1 to 11.

Aspect 41. A non-transitory computer-readable medium having stored thereon instructions that, when executed by at least one processor, cause the at least one processor to perform operations according to any of Aspects 31 to 38.

Aspect 42. An apparatus for three-dimensional reconstruction (3DR) of a scene, comprising one or more means for performing operations according to any of Aspects 31 to 38.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A method for three-dimensional reconstruction (3DR) of a scene, the method comprising:
projecting, during a first operational pass, a block of the scene onto a depth frame;
performing, during the first operational pass, depth integration on the block to produce an updated depth block;
storing, during the first operational pass, color integration metadata for the block in a color metadata buffer;
projecting, during a second operational pass, the updated depth block onto a color frame; and
performing, during the second operational pass, color integration on the updated depth block using the color integration metadata to produce an updated depth and color block.

2. The method of claim 1, further comprising prefetching and caching, during the first operational pass, the depth frame into memory.

3. The method of claim 2, further comprising prefetching and caching, during the second operational pass, the color frame into the memory.

4. The method of claim 1, wherein the first operational pass is performed prior to the second operational pass.

5. The method of claim 1, wherein the color integration metadata indicates whether to update the block with color.

6. The method of claim 5, wherein the color integration metadata comprises a respective single bit of data for each block of a plurality of blocks of the scene, wherein a first value for a first bit of the color integration metadata corresponding to a first block indicates that the first block is to be updated with color and a second value for the first bit indicates that the first block is not to be updated with color.

7. The method of claim 1, wherein the block is a voxel.

8. The method of claim 1, wherein the scene is modeled as a volume grid comprising a plurality of blocks comprising the block.

9. The method of claim 1, further comprising determining a depth value for the block during the depth integration.

10. The method of claim 9, further comprising determining whether the block is located on a surface of one of an object or an obstruction, based on the depth value.

11. The method of claim 10, further comprising determining whether the block can be updated with color, based on determining of whether the block is located on the surface of one of the object or the obstruction.

12. An apparatus for three-dimensional reconstruction (3DR) of a scene, the apparatus comprising:
a color metadata buffer; and
at least one processor coupled to the color metadata buffer and configured to:
project, during a first operational pass, a block of the scene onto a depth frame;
perform, during the first operational pass, depth integration on the block to produce an updated depth block;
store, during the first operational pass, color integration metadata for the block in the color metadata buffer;
project, during a second operational pass, the updated depth block onto a color frame; and
perform, during the second operational pass, color integration on the updated depth block using the color integration metadata to produce an updated depth and color block.

13. The apparatus of claim 12, further comprising memory to prefetch and cache, during the first operational pass, the depth frame.

14. The apparatus of claim 13, wherein the memory is further configured to prefetch and cache, during the second operational pass, the color frame.

15. The apparatus of claim 12, wherein the first operational pass is performed prior to the second operational pass.

16. The apparatus of claim 12, wherein the color integration metadata indicates whether to update the block with color.

17. The apparatus of claim 16, wherein the color integration metadata comprises a respective single bit of data for each block of a plurality of blocks of the scene, wherein a first value for a first bit of the color integration metadata corresponding to a first block indicates that the first block is to be updated with color and a second value for the first bit indicates that the first block is not to be updated with color.

18. The apparatus of claim 12, wherein the block is a voxel.

19. The apparatus of claim 12, wherein the scene is modeled as a volume grid comprising a plurality of blocks comprising the block.

20. The apparatus of claim 12, wherein the at least one processor is further configured to determine a depth value for the block during the depth integration.

21. The apparatus of claim 20, wherein the at least one processor is further configured to determine whether the block is located on a surface of one of an object or an obstruction, based on the depth value.

22. The apparatus of claim 21, wherein the at least one processor is further configured to determine whether the block can be updated with color, based on determining whether the block is located on the surface of one of the object or the obstruction.

23. A non-transitory computer-readable medium having stored thereon instructions that, when executed by at least one processor, cause the at least one processor to:
project, during a first operational pass, a block of the scene onto a depth frame;
perform, during the first operational pass, depth integration on the block to produce an updated depth block;
store, during the first operational pass, color integration metadata for the block in a color metadata buffer;
project, during a second operational pass, the updated depth block onto a color frame; and
perform, during the second operational pass, color integration on the updated depth block using the color integration metadata to produce an updated depth and color block.

24. The non-transitory computer-readable medium of claim 23, wherein the instructions, when executed by the at least one processor, cause the at least one processor to prefetch and cache, during the first operational pass, the depth frame to a memory.

25. The non-transitory computer-readable medium of claim 24, wherein the instructions, when executed by the at least one processor, cause the at least one processor to prefetch and cache, during the second operational pass, the color frame to the memory.

26. The non-transitory computer-readable medium of claim 23, wherein the first operational pass is performed prior to the second operational pass.

27. The non-transitory computer-readable medium of claim 23, wherein the color integration metadata indicates whether to update the block with color.

28. The non-transitory computer-readable medium of claim 27, wherein the color integration metadata comprises a respective single bit of data for each block of a plurality of blocks of the scene, wherein a first value for a first bit of the color integration metadata corresponding to a first block indicates that the first block is to be updated with color and a second value for the first bit indicates that the first block is not to be updated with color.

30. The apparatus of claim 23, wherein the scene is modeled as a volume grid comprising a plurality of blocks comprising the block.
